(19) United States
(12) Patent Application Publication
(10) Pub. No.: US 2009/0237710 A1
(43) Pub. Date: Sep. 24, 2009

(54) METHOD OF TRANSMITTING/RECEIVING DATA BETWEEN IMAGE FORMING DEVICE AND PORTABLE STORAGE DEVICE, AND IMAGE FORMING DEVICE FOR PERFORMING THE METHOD

(75) Inventor: Joo-chul LEE, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/251,543

(22) Filed: Oct. 15, 2008

(30) Foreign Application Priority Data
Mar. 19, 2008 (KR) 2008-25590

(51) Int. Cl. G06F 3/12

(52) U.S. Cl. 358/1.15

(57) ABSTRACT

A method of transmitting/receiving data between an image forming device and a portable storage device includes reading information about the portable storage device from the portable storage device when such is connected to the image forming device, transmitting/receiving data with respect to the portable storage device according to the read information, stopping the transmitting/receiving of data when the portable storage device is disconnected during the transmitting/receiving of data, and resuming the transmitting/receiving of data when the portable storage device is reconnected to the image forming device and the disconnected portable storage device and the reconnected portable storage device are the same. When the connection between the image forming device and the portable storage device is lost and the transmitting/receiving of data therebetween is stopped, the transmitting/receiving of data between the image forming device and the portable storage device can resume when the connection is restored.

### CROSS-REFERENCE TO RELATED APPLICATIONS

This application claims the benefit of Korean Patent Application No. 2008-25590, filed on Mar. 19, 2008, in the Korean Intellectual Property Office, the disclosure of which is incorporated herein by reference.

### BACKGROUND OF THE INVENTION

1. Field of the Invention

Aspects of the present invention relate to a method of transmitting/receiving data between an image forming device and a portable storage device, and an image forming device that performs the method, and more particularly, to a method of resuming the transmitting/receiving of data between an image forming device and a portable storage device when the connection between the image forming device and the portable storage device is lost during the transmitting/receiving of data and is then restored, and an image forming device that performs the method.

2. Description of the Related Art

In general, multifunction products (MFPs) are office automation devices that can simultaneously perform various functions, such as the functions of a printer, a copier, a scanner, and a facsimile used in an office, within a single device. Since the MFP performs a variety of functions, scan data can be generated using a scan function, and the generated scan data can be stored in the MFP. Although data, such as the scan data, generated by the MFP and data previously stored in the MFP can be directly output from the MFP, the data can be used by other devices.

Thus, a portable storage device, such as a USB (universal serial bus) memory stick, may be connected to the MFP to use the internal data outside of the MFP, and the data may be stored in the portable storage device connected to the MFP. Also, to use the data stored in the portable storage device at the MFP, the data stored in the portable storage device is stored in the MFP. That is, the MFP and the portable storage device transmit and receive data between each other.

However, when the connection between the portable storage device and the MFP is lost during storing of the data in the portable storage device connected to the MFP, access to the portable storage device is denied so that a data transmitting/receiving job between the portable storage device and the MFP is canceled. Thus, when the portable storage device and the MFP are reconnected to continue the data transmitting/receiving job between the portable storage device and the MFP, the data needs to be inconveniently transmitted/received again from the beginning. This problem occurs not only to the MFP performing two or more functions but also to an image forming device.

### SUMMARY OF THE INVENTION

To solve the above and/or other problems, aspects of the present invention provide a method of resuming transmitting/receiving data between an image forming device and a portable storage device without transmitting/receiving the data again from the beginning when the connection between the image forming device and the portable storage device is lost during the transmitting/receiving of data and is then restored.

Aspects of the present invention provide a computer-readable recording medium having recorded thereon a program for executing the method.

According to an aspect of the present invention, a method of transmitting/receiving data between an image forming device and a portable storage device includes reading information about the portable storage device from the portable storage device when the portable storage device is connected to the image forming device, transmitting/receiving data with respect to the portable storage device by using the read information, stopping the transmitting/receiving of data when the portable storage device is disconnected during the transmitting/receiving of data, and resuming the transmitting/receiving of data when the portable storage device is reconnected to the image forming device and the disconnected portable storage device and the reconnected portable storage device are the same.

According to another aspect of the present invention, a computer readable recording medium having recorded thereon a program for executing the above method and implemented by a computer is provided.

According to another aspect of the present invention, an image forming device includes an information reading unit reading information about a portable storage device from the portable storage device when the portable storage device is connected to the image forming device via a port, and a storage device connection unit transmitting/receiving data with respect to the portable storage device according to the read information, wherein the storage device connection unit stops transmitting/receiving of data when the image forming device is disconnected from the portable storage device during the transmitting/receiving of data, and resumes the transmitting/receiving of data when the portable storage device is reconnected to the image forming device and the disconnected portable storage device and the reconnected portable storage device are the same.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates the connection between an image forming device and a portable storage device;

FIGS. 2A and 2B provide a flow chart explaining a method of transmitting/receiving data between the image forming device and the portable storage device according to an embodiment of the present invention;

FIG. 3 is a flow chart for explaining a step of transmitting/receiving data between the image forming device and the portable storage device according to an embodiment of the present invention;

FIG. 4 illustrates an interface provided when the connection between the image forming device and the portable storage device is lost according to an embodiment of the present invention;

FIG. 5 illustrates an interface provided when the connection between the image forming device and the portable storage device is restored according to an embodiment of the present invention;

FIG. 6 illustrates an interface provided when a portable storage device that is not the one that was initially connected to the image forming device is connected to the image forming device according to an embodiment of the present invention; and

FIG. 7 is a block diagram of an image forming device capable of performing the method of transmitting/receiving data between the image forming device and the portable storage device according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

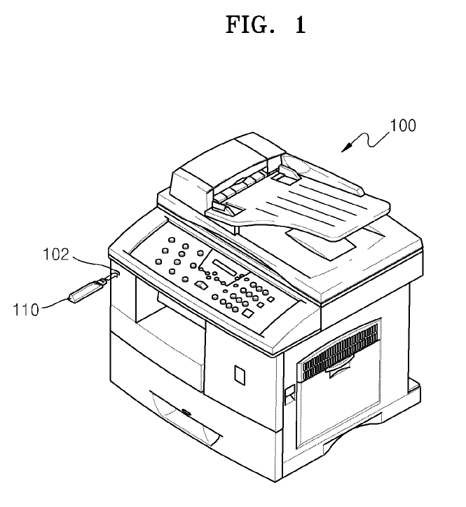

FIG. 1 illustrates the connection between an image forming device and a portable storage device. Referring to FIG. 1, a portable storage device 110, such as a USB memory stick, is inserted into a port 102 of an image forming device 100. The portable storage device 110 is connected to the image forming device 100 by being inserted into the port 102 of the image forming device 100. The image forming device 100 is not limited thereto such that the image forming device 100 may be a multifunction product (MFP), a desktop or a laptop computer, a handheld, portable, or other device having an appropriate port. Further, although the portable storage device 110 is described as being inserted into the port 102 of the image forming device 100, aspects of the present invention are not limited thereto such that the portable storage device 110 may be connected to the image forming device 100 via a wireless port, such as via a Wi-Fi, a Wi-Max, an HSPA, a UMTS, a GSM, a wireless network, a Bluetooth connection, an infrared connection, or a radio connection, or the like.

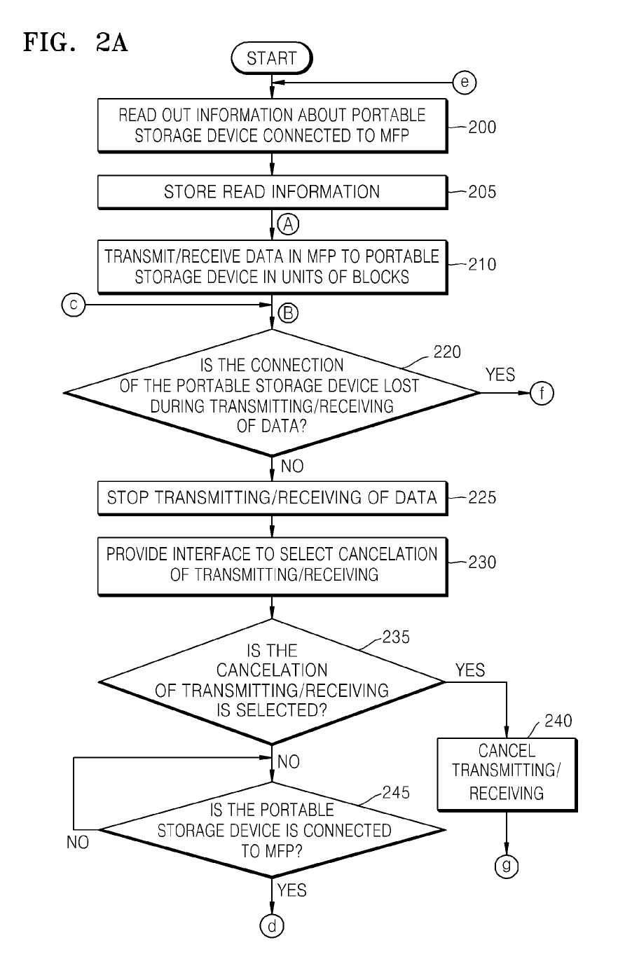

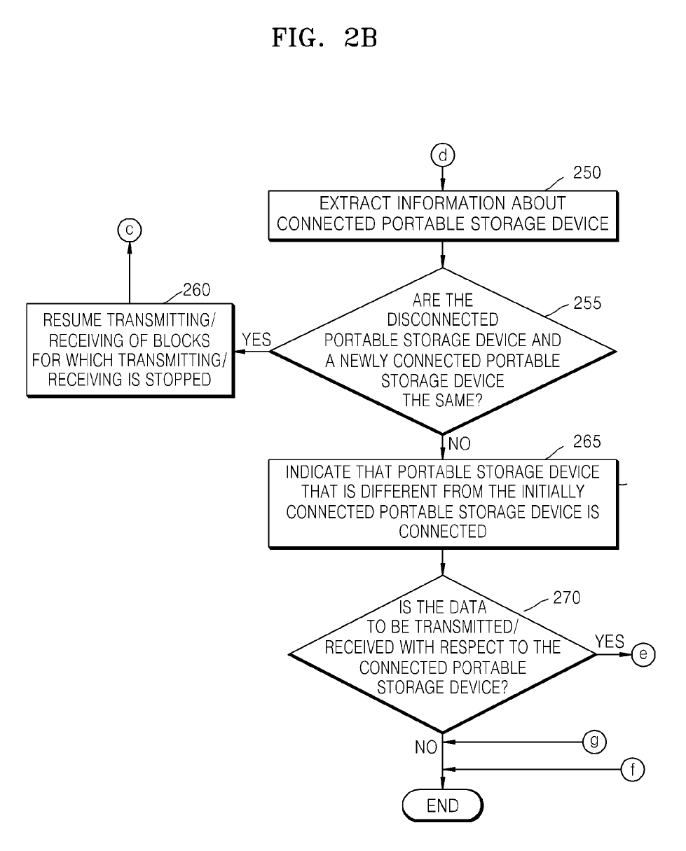

FIGS. 2A and 2B provide a flow chart illustrating a method of transmitting/receiving data between an image forming device and a portable storage device according to an embodiment of the present invention. Referring to FIG. 2A, in operation 200, the image forming device 100 reads out information about the portable storage device 110 connected to the image forming device 100. In detail, when the image forming device 100 and the portable storage device 110 are connected by inserting the portable storage device 110 in a port 120 of the image forming device 100, the image forming device 100 reads out information about the type, identification, and file system of the portable storage device 110 connected to the image forming device 100. The portable storage device 110 may be a universal serial bus (USB) memory stick or a portable hard disk drive (HDD), which are portable and can be connected to and disconnected from the image forming device 100. Also, the ID information of the portable storage device 110 may be a device ID or a serial number that is intrinsic information which can be electrically identified and separately assigned to a device.

In operation 205, the image forming device 100 stores the information read out from the portable storage device 110. The image forming device 100 may store the information read out from the portable storage device 110 in a storage unit of the image forming device 100. In operation 210, the image forming device transmits/receives data with the portable storage device 110.

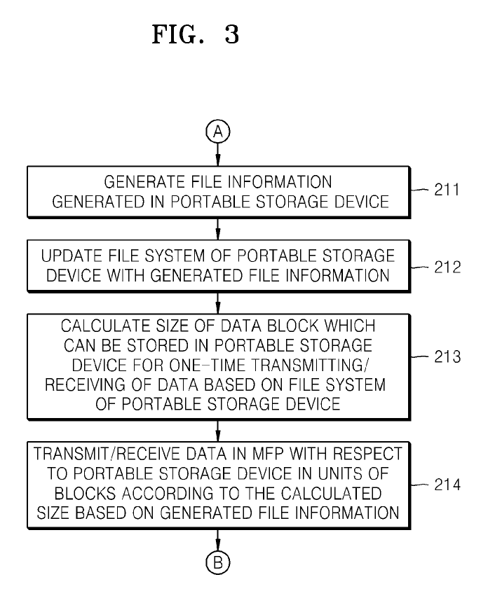

FIG. 3 is a flow chart illustrating aspects of operation 210 of FIG. 2A and the transmitting/receiving data between the image forming device 100 and the portable storage device 110 according to an embodiment of the present invention.

In operation 211, file information to be generated in the portable storage device 110 is generated. In general, data that can be output from the image forming device 100 is stored in the storage unit of the image forming device 100. The data may be, for example, scan image data generated by scanning an image in the image forming device 100. The image forming device 100 generates the file information to be generated from the portable storage device 110 based on the data stored in the image forming device 100 and the structure of the file system of the portable storage device 110. The file information may include information about the name of a file to be generated and the physical position where data is to be stored and the position of the file in the file system of the portable storage device 110.

In operation 212, the file system of the portable storage device 110 is updated with the file information generated in the image forming device 100. The image forming device 100 accesses the file system of the portable storage device 110 to update the file system of the portable storage device 110 with the file information generated in operation 211.

In operation 213, the size of a data block in which data may be stored in the portable storage device 110, for the one-time transmitting/receiving of data, is calculated based on the file system of the portable storage device 110. The calculated size of the data block is set to a particular size based on characteristics of the file system of the portable storage device 110. Also, the size of the data block may be calculated in units of bytes for convenience of calculation.

In operation 214, the data in the image forming device 100 is transmitted/received with respect to the portable storage device 110 in the units of blocks according to the calculated size, based on the file information generated by the image forming device 100. The data in the units of blocks is sequentially stored at a physical position where the data included in the file information is stored. However, aspects of the present invention are not limited thereto such that the data may be stored in the portable storage device 110 according to other methods of data storage.

Referring back to FIG. 2, in operation 220, while data is transmitted and received with respect to the portable storage device 110, it is checked whether the connection of the portable storage device 110 is lost. When the connection of the portable storage device 110 is duly maintained, the step of transmitting/receiving data is completed after the transmitting/receiving of data between the image forming device 100 and the portable storage device 110 is fully completed and the method is finished. In contrast, when the connection of the portable storage device 110 is lost, the method proceeds to operation 225.

In operation 225, the transmitting/receiving of data is stopped when it is determined that the connection between the image forming device 100 and the portable storage device 110 is lost. According to the method of transmitting/receiving data from the image forming device 100 to the portable storage device 110 according to an embodiment of the present invention, the transmitting/receiving of data from the image forming device 100 to the portable storage device 110 is performed in units of blocks, and when the connection of the portable storage device 110 is lost, the transmitting/receiving of data blocks from the image forming device 100 to the portable storage device 110 is stopped.

A message 400 indicating that the connection of the image forming device 100 and the portable storage device 110 is lost may be indicated through a user interface unit. In operation 230, an interface communicates the message 400 and the user can select cancellation of the transmitting/receiving is provided. The image forming device 100 can provide an interface requesting whether to select cancelation of the transmitting/receiving through the user interface unit.

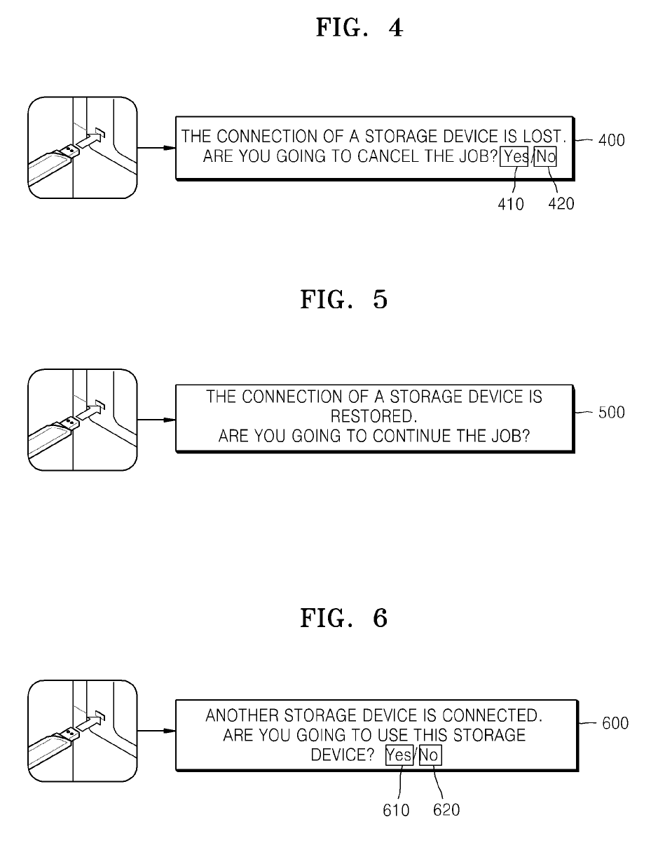

FIG. 4 illustrates the message 400 provided when the connection between the image forming device 100 and the portable storage device 110 is lost in the method of transmitting/receiving data between the image forming device 100 and the portable storage device 110 according to an embodiment of the present invention. As shown in FIG. 4, when the connection between the image forming device 100 and the portable storage device 110 is lost, the message 400 communicates that the connection is lost. The transmitting/receiving job may or may not be canceled according to the selection between a button “YES” 410 or a button “NO” 420.

Referring back to FIG. 2, in operation 235, the selection of the cancelation of the transmitting/receiving is input. When the message 400 is provided through the user interface unit as shown in FIG. 4 and the button “YES” 410 is selected in the provided interface, the cancelation of the transmitting/receiving is input and then operation 240 is performed. In contrast, when the button “NO” 420 is selected so that the cancelation of the transmitting/receiving is not input, operation 245 is performed.

In operation 240, the transmitting/receiving job is canceled. The file information generated in the image forming device 100 is erased so that the transmitting/receiving of the data from the image forming device 100 to the portable storage device 110 is canceled.

In operation 245, it is checked whether the portable storage device 110 is connected to the image forming device 100. operation 245 for checking the connection of the portable storage device 110 to the image forming device 100 is repeatedly performed until the portable storage device 110 is determined to be connected to the image forming device 100, in which case operation 250 is performed.

In operation 250, information about a connected portable storage device 110 is read out. In detail, when the portable storage device 110 is connected to the image forming device 100, the image forming device 100 reads out information about the type, identification, and file system of the portable storage device 110 from the connected portable storage device 110. The portable storage device 110 may be a USB memory stick or a portable HDD, which is portable and can be connected to and disconnected from the image forming device 100. Also, the ID information of the portable storage device 110 may be a device ID or a serial number that is intrinsic information which can be electrically identified and separately assigned to a device.

In operation 255, it is determined whether the disconnected portable storage device 110 and a newly connected portable storage device 110 are the same device. Whether the disconnected portable storage device 110 and the newly connected portable storage device 110 are the same device is determined by comparing the information (first information) stored in the image forming device 100 in operation 205 and the information (second information) read out in operation 250. As a result of the comparison, when the first information and the second information are the same, the devices are determined to be the same. Otherwise, the devices are determined to be different from each other, i.e., when the first information and the second information are determined to be different. When the devices are determined to be the same, operation 260 is performed. When the devices are determined to be different from each other, operation 265 is performed.

In operation 260, the transmitting/receiving of the blocks for which transmitting/receiving was previously stopped in operation 225 is continued. When the connection of the portable storage device 110 is lost and the transmitting/receiving of data is stopped in operation 225, the file information at the time when the final data block is stored and data blocks to be transmitted/received after the connection is lost are kept in the image forming device 100, and information about the position where the data block for which transmitting/receiving is stopped is to be stored in included in the file information. Thus, the blocks for which transmitting/receiving is stopped can be stored in the portable storage device 110. When the file system of the portable storage device 110 is damaged, the file system of the portable storage device 110 is reconfigured or updated based on the file information read out in operation 200. According to the above operations, an error in the file system due to the disconnection can be solved. When the transmitting/receiving resumes, the final data block and the data blocks to be transmitted/received may be transmitted/received, or only the data blocks not previously transmitted/received may be transmitted/received, or a partial data block and the data blocks not previously transmitted/received may be transmitted/received, and the file information of portable storage device 110 may indicate such. Also, even when data is continuously stored in the portable storage device 110 in operation 260, the operation of checking whether the connection of the portable storage device 110 in operation 220 is performed. As the portable storage device 110 that is disconnected from the image forming device 100 is reconnected, a message indicating the continuation of the storage job may be indicated.

FIG. 5 illustrates an interface provided when the connection between the image forming device 100 and the portable storage device 110 is restored in the method of transmitting/receiving data between the image forming device 100 and the portable storage device 110 according to an embodiment of the present invention. Referring to FIG. 5, when the portable storage device 110 that is disconnected from the image forming device 100 is reconnected, a message 500 indicating that the portable storage device 110 is reconnected to the image forming device 100 so that the storage job can be continued is indicated, thus making a user aware of the reconnection of the portable storage device 110.

Referring back to FIG. 2, in operation 265, it is indicated that another portable storage device 110 different from the initially connected portable storage device 110 is connected. The image forming device 100 provides an interface indicating that another portable storage device 110 that is different from the portable storage device 110 for which a data transmitting/receiving job is discontinued is connected to the image forming device 100, through the user interface unit, and receives an input of a selection of whether to perform the transmitting/receiving job with respect to the connected portable storage device 110 through the provided interface in operation 270. Further, when a memory of the portable storage device 110 is full, a second portable storage device 110 may be connected to the image forming device 100 and the data transmission/receipt may continue according to the operation 270.

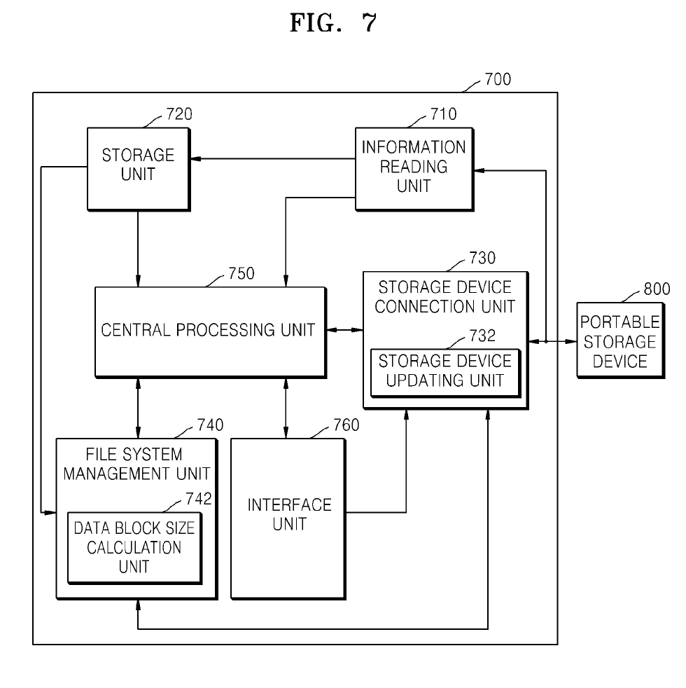

FIG. 6 illustrates an interface provided when a portable storage device 110 that is not the one initially connected to the image forming device 100 is connected to the image forming device 100 in the method of transmitting/receiving data between the image forming device 100 and the portable storage device 110 according to an embodiment of the present invention. As shown in FIG. 6, when another portable storage device 110 that is different from the initially connected portable storage device 110, is connected to the image forming device 100, a message 600 indicating that a different portable storage device 110 is connected and enabling a selection of whether to use the connected portable storage device 110 is provided. According to the selection of either a button “YES” 610 or a button “NO” 620, the transmitting/receiving job may be performed or not with respect to the connected portable storage device 110.

Referring back to FIG. 2, in operation 270, a selection of whether to perform the data transmitting/receiving job for the connected portable storage device 110 is input. The message 600 of FIG. 6 for selecting whether to transmit/receive data with respect to the portable storage device 110 that is presently connected is provided in operation 265. When the button “YES” 610 is selected from the provided interface 600 and thus a selection to perform the data transmitting/receiving with respect to the connected portable storage device 110 is input, operation 200 is performed. In contrast, when the button “NO” 620 is selected and thus a selection of not transmitting/receiving data with respect to the connected portable storage device 110 is input, the process of transmitting/receiving data with the portable storage device 110 is completed.

FIG. 7 is a block diagram of an image forming device 700 that performs the method of transmitting/receiving data between the image forming device and the portable storage device according to an embodiment of the present invention. Referring to FIG. 7, the image forming device 700 includes an information reading unit 710, a storage unit 720, a storage device connection unit 730, a file system management unit 740, a central processing unit 750, and an interface unit 760. The image forming device 700 is not limited thereto such that the image forming device may be a multifunction product as described above.

When a portable storage device 800 is connected via a port, the information reading unit 710 reads out information on the connected portable storage device. The information about the portable storage device includes information about the type, ID, and file system of a portable storage device 800. Also, the ID information of the portable storage device 800 may be a device ID or a serial number that is intrinsic information which can be electrically identified and separately assigned to a device. The read information is transferred to the storage unit 720. Also, after the portable storage device 800 is disconnected from the information reading unit 710 and then reconnected, the information about the reconnected portable storage device 800 is read out. That is, the information reading unit 710 reads out the information about the connected portable storage device 800 whenever the portable storage device 800 is connected. However, the read information is transferred to the storage unit 720 only when the read information is not stored in the storage unit 720.

The storage unit 720 receives the read information from the information reading unit 710 and stores the received information. Also, the storage unit 720 stores data generated by the image forming device 700 and data that can be output from the image forming device 700.

The file system management unit 740 generates file information generated at the portable storage device 800 based on the information and data stored in the storage unit 720. The file information includes information about the name of a file to be generated, the position of a file in the file system of the portable storage device 800, and the physical position where data is stored. The generated file information is transferred to the storage device connection unit 730. Also, the file system management unit 740 includes a data block size calculation unit 742. The data block size calculation unit 742 receives an updated file system of the portable storage device 800 from the storage device connection unit 730 and calculates the size of a data block in which data may be stored in the connected portable storage device 800 for one-time transmitting/receiving of data based on the received file system of the portable storage device 800. The data block size calculation unit 742 transfers the calculated block size to the storage device connection unit 730.

The storage device connection unit 730 includes a storage device updating unit 732 which updates the file system of the connected portable storage device 800 with the file information received from the file system management unit 740. The storage device connection unit 730 updates the file system of the portable storage device 800 using the storage device updating unit 732 and transfers the updated file system of the portable storage device 800 to the file system management unit 740. Also, the storage device connection unit 730 transmits/receives the data stored in the storage unit 720 in units of blocks to the connected portable storage device 800 based on the file information received from the file system management unit 740. In detail, the storage device connection unit 730 transfers the data stored in the storage unit 720 in units of blocks according to the size calculated by the data block size calculation unit 742 to the connected portable storage device 800 based on the file information received from the file system management unit 740. When the connection of the portable storage device 800 connected via the port is removed, the storage device connection unit 730 stops the data transmitting/receiving of the data blocks after the connection is lost. Also, when the portable storage device 800 is reconnected, the storage device connection unit 730 notifies the central processing unit 750 about the reconnection.

When receiving the reconnection of the portable storage device 800 from the storage device connection unit 730, the central processing unit 750 receives the information (first information) stored in the storage unit 720 and the information (second information) read out by the information reading unit 710 and compares the received first and second information. As a result of the comparison, when the first and second information are the same, it is determined that the reconnected portable storage device 800 is the same as the disconnected portable storage device 800. Otherwise, it is determined that the reconnected portable storage device 800 is not the same as the disconnected portable storage device 800. Also, the central processing unit 750 transfers the result of the comparison to the storage device connection unit 730 and the interface unit 760.

The interface unit 760 receives from the central processing unit 750 the result of the comparison as to whether the disconnected portable storage device 800 and the reconnected portable storage device 800 are the same. When receiving from the central processing unit 750 the comparison result that the disconnected portable storage device 800 and the reconnected portable storage device 800 are not the same, the interface unit 760 indicates the connection of a different portable storage device 800 and provides a message to receive a selection of whether to store data in the reconnected portable storage device 800. The interface unit 760 may provide the message of FIG. 6. Then, the button “YES” 610 or “NO” 620 is selected from the provided message and the selected result is transferred to the storage device connection unit 730. When receiving from the central processing unit 750 the comparison result that the disconnected portable storage device 800 and the reconnected portable storage device 800 are the same, as shown in FIG. 5, a message 500 indicating that the connection of the portable storage device 800 is restored and that the storage job is continuing is provided.

The storage device connection unit 730 receives from the central processing unit 750 the comparison result as to whether the disconnected portable storage device 800 and the reconnected portable storage device 800 are the same. When receiving the comparison result that the disconnected portable storage device 800 and the reconnected portable storage device 800 are the same, the storage device connection unit 730 resumes the storing of the data blocks for which transmitting/receiving was previously stopped. The data blocks for which transmitting/receiving is stopped are transmitted/received with respect to the portable storage device 800 by referring to the file information of the final data blocks that were transmitted/received at the moment when the data transmitting/receiving is stopped. That is, the storage device connection unit 730 performs the data transmitting/receiving with respect to the portable storage device 800 by matching the data blocks for which transmitting/receiving is stopped to the physical position where the data included in the file information is to be stored.

Aspects of the present invention can also be embodied as computer readable codes on a computer readable recording medium. The computer readable recording medium may be any data storage device that can store data that can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

As described above, according to aspects of the present invention, even when the connection between an image forming device and a portable storage device is lost, and thus the transmitting/receiving of data from the image forming device to the portable storage device is stopped, the transmitting/receiving of data between the image forming device and the portable storage device can resume when the connection is restored.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of transmitting/receiving data between an image forming device and a portable storage device, the method comprising:
reading information about the portable storage device from a first portable storage device when the first portable storage device is connected to the image forming device;
transmitting/receiving data with respect to the first portable storage device according to the read information;
stopping the transmitting/receiving of data when the first portable storage device is disconnected during the transmitting/receiving of data; and
resuming the transmitting/receiving of data when a second portable storage device is connected to the image forming device and the second portable storage device and the first portable storage device are the same.

2. The method of claim 1, wherein, in the transmitting/receiving of the data, the data is transmitted/received in units of blocks according to the image forming device and a file system of the portable storage device

3. The method of claim 2, further comprising:
calculating a size of a block of the transmitted/received data based on the file system,
wherein, in the transmitting/receiving of data, the data is transmitted/received in units of blocks according to a calculated block size.

4. The method of claim 2, further comprising:
updating the file system when the transmitting/receiving of one of the blocks of the data transmitted/received in units of blocks is completed.

5. The method of claim 1, wherein the transmitted/received data is sequentially stored.

6. The method of claim 1, wherein the transmitting/receiving of data further comprises:
determining whether an error occurs in the transmitting/receiving of the data, and
determining whether the connection between the image forming device and the portable storage device is lost.

7. The method of claim 1, wherein the stopping of the transmitting/receiving of data further comprises:
providing a message to a user via an interface requesting whether to cancel the transmitting/receiving of data when the connection between the image forming device and the portable storage device is lost.

8. The method of claim 7, wherein the stopping of the transmitting/receiving of data further comprises:
canceling the transmitting/receiving of data when the cancellation of the transmitting/receiving of data is received via the interface or there is no input via the interface for a predetermined time.

9. The method of claim 8, further comprising erasing data from the image forming device for which transmitting/receiving is stopped.

10. The method of claim 2, wherein, in the resuming of the transmitting/receiving of data, the transmitting/receiving of data is resumed from a data block for which transmitting/receiving is stopped according to the file system.

11. The method of claim 1, wherein the resuming of the transmitting/receiving of data further comprises requesting whether to continue the transmitting/receiving of data when the first portable storage device and the second portable storage device are not the same.

12. A computer readable recording medium having recorded thereon a program for executing the method of claim 1 and implemented by a computer.

13. An image forming device, comprising:
an information reading unit to read information about a portable storage device from the portable storage device when the portable storage device is connected to the image forming device via a port; and
a storage device connection unit to transmit/receive data with respect to the portable storage device according to the read information,
wherein the storage device connection unit stops the transmission/receipt of the data when the image forming device is disconnected from the portable storage device during the transmission/reception of the data, and the storage device connection unit resumes the transmission/reception of the data when the portable storage device is reconnected to the image forming device and the disconnected portable storage device and the reconnected portable storage device are the same.

14. The image forming device of claim 13, wherein the storage device connection unit transmits/receives the data in units of blocks according to the image forming device and a file system of the portable storage device.

15. The image forming device of claim 13, further comprising a data block size calculation unit calculating the size of a block of the transmitted/received data based on a file system of the portable storage device,
wherein the storage device connection unit transmits/receives the data in units of blocks according to a calculated block size.

16. The image forming device of claim 15, wherein the storage device connection unit comprises a storage device updating unit to update the file system when the transmission/receipt of one of the blocks of the data transmitted/received in units of blocks is completed.

17. The image forming device of claim 16, wherein the transmitted/received data is sequentially stored.

18. The image forming device of claim 13, wherein the storage device connection unit determines whether an error occurs in the transmission/receipt of the data and whether the connection between the image forming device and the portable storage device is lost.

19. The image forming device of claim 18, further comprising:
a storage unit to store the transmitted/received data,
wherein the storage device connection unit erases from the storage unit the transmitted/received data for which the transmission/receipt is stopped when the cancellation of the transmission/receipt of the data is input through the interface unit.

20. The image forming device of claim 14, wherein the storage device connection unit resumes the transmission/receipt of the data block for which the transmission/receipt is stopped according to the data previously transmitted/received to/from the file system.

21. The image forming device of claim 14, wherein the storage device connection unit resumes the transmission/receipt of the data block by overwriting a partially transmitted/received data block.

22. The image forming device of claim 13, further comprising:
a storage unit to receive the read information about the portable storage device from the information reading unit and to store the read information.

23. The image forming device of claim 13, further comprising:
a storage unit to store the data transmitted/received with respect to the portable storage device.
